(19) United States
(12) Patent Application Publication
(10) Pub. No.: US 2024/0117118 A1
(43) Pub. Date: Apr. 11, 2024

(54) Composition for Forming Polyimide Film for Cover Window, Process for Preparing the Same and Uses Thereof

(71) Applicants: SK Innovation Co., Ltd., Seoul (KR); SK ie technology Co., Ltd., Seoul (KR)

(72) Inventors: Hye Jin Park, Daejeon (KR); Cheol Min Yun, Daejeon (KR)

(21) Appl. No.: 17/946,120

(22) Filed: Sep. 16, 2022

(51) Int. Cl. C08G 73/10

(52) U.S. Cl. CPC C08G 73/1067

(57) ABSTRACT

Provided is a composition for forming a polyimide film for a cover window capable of satisfying a high performance required for the cover window, a process for preparing the same, and a use thereof. According to an embodiment, the composition may be usefully utilized in flexible display devices of various aspects providing a colorless and transparent film for a cover window that has excellent visibility without optical mura and deterioration in optical properties, and has excellent heat resistance and mechanical properties for use in optical applications.

### CROSS-REFERENCE TO RELATED APPLICATION

This application claims priority to Korean Patent Application No. 10-2021-0124489, filed Sep. 17, 2021, the disclosure of which is hereby incorporated by reference in its entirety.

### BACKGROUND OF THE INVENTION

### Field of the Invention

The following disclosure relates to a composition for forming a polyimide film for a cover window, a process for preparing the same, and a use thereof.

### Description of Related Art

A display device includes a cover window for the display device on a display panel in order to protect the display panel from scratches or external impact. Recently, a flexible display panel that is bent or curved flexibly has been in the spotlight as a next-generation display, and a polymer material capable of imparting flexibility as a cover window material of such a next-generation display has been spotlighted. Among them, polyimide (PI), a polymer that is easy to synthesize and has excellent heat resistance and chemical resistance, has been mainly used.

However, in order to enable the polyimide film to be applied to the display device, it is essential to improve inherent yellowness index properties and impart colorless and transparent performance. Furthermore, in order to enable the polyimide film to be applied to a foldable or flexible display device, it is necessary to accompany the improvement of mechanical properties, and thus the required performance of a cover window material for a display device has gradually become high.

For this purpose, research has been continuously conducted to reduce a CTC effect by combining or changing monomers having various structures, but there is still a limitation in that residual yellowness appears and the yellowness index increases as a thickness of the film increases. In addition, since optical properties and mechanical properties have a trade-off relationship with each other, such an attempt inevitably yields extremely general results in that, although the optical properties of the polyimide are improved, the functionality is decreased or the mechanical properties are degraded.

### SUMMARY OF THE INVENTION

An embodiment is directed to providing a composition for forming a polyimide film for a cover window capable of satisfying a high performance required for the cover window, and a polyimide film for a cover window prepared therefrom.

Specifically, an embodiment may provide a polyimide film for a cover window capable of simultaneously implementing excellent mechanical properties while being colorless and transparent.

Another embodiment is directed to providing a method of manufacturing a composition for forming a polyimide film for a cover window for implementing the above-described physical properties, and a process for preparing the polyimide film for a cover window.

Still another embodiment is directed to providing a multilayer structure including the polyimide film for a cover window.

Still further another embodiment is directed to providing a cover window made of a new material that may replace tempered glass, etc., and a flexible display device including the same.

In one general aspect, a composition for forming a polyimide film for a cover window includes: a polyamic acid or polyimide including a structural unit derived from a dianhydride and a structural unit derived from a diamine; and a mixed solvent of an amide-based solvent and a hydrocarbon-based solvent, and satisfies the following Equation 1, wherein the structural unit derived from the dianhydride includes a structural unit derived from a compound represented by the following Formula 1, and the structural unit derived from the diamine includes a structural unit derived from a compound represented by the following Formula 2:

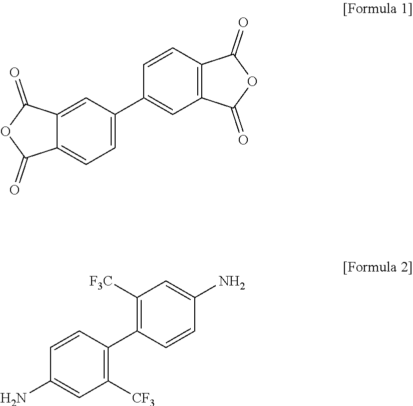

7,000≤V_{PI}≤20,000 [Equation 1]

wherein

V_{PI} is a viscosity of a composition for forming a polyimide film for a cover window when a solid content is 15% by weight based on the total weight of the composition for forming a polyimide film for a cover window, and the viscosity is a viscosity (unit, cp) measured with a Brookfield rotational viscometer at 25° C. using a 52Z spindle based on a torque of 80% for 2 minutes

The structural unit derived from the dianhydride may further include a structural unit derived from a compound represented by the following Formula 3:

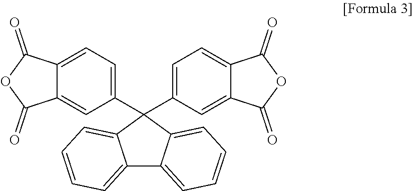

The structural unit derived from the compound represented by Formula 3 may be included in an amount of 10 to 50 mol % based on 100 mol % of the structural unit derived from the dianhydride.

The amide-based solvent may include dimethylpropionamide.

The hydrocarbon-based solvent may be a cyclic hydrocarbon-based solvent.

The cyclic hydrocarbon-based solvent may be toluene, benzene, cyclohexane, or a combination thereof.

The composition for forming a polyimide film for a cover window may include the amide-based solvent and the hydrocarbon-based solvent in a weight ratio of 8:2 to 5:5.

A solid content of the composition for forming a polyimide film for a cover window may be included in an amount of 10 to 40% by weight based on the total weight of the composition for forming a polyimide film.

In another general aspect, a process for preparing a composition for forming a polyimide film for a cover window includes the steps of: step (A) preparing a polyamic acid solution by reacting a compound represented by the following Formula 1 and a compound represented by the following Formula 2 in an amide-based solvent; and step (B) adjusting a viscosity by additionally adding a hydrocarbon-based solvent to satisfy the following Equation 1:

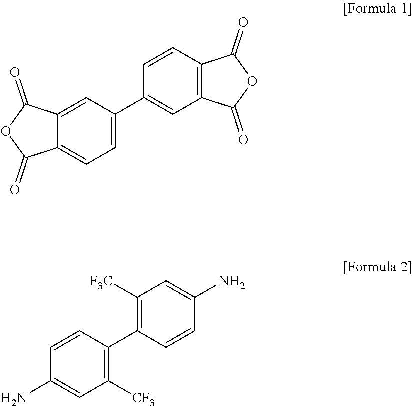 [SMILES: O=C1OC(=O)c2cc(-c3ccc4c(c3)C(=O)OC4=O)ccc21 ; Nc1ccc(-c2ccc(N)cc2C(F)(F)F)c(C(F)(F)F)c1]

7,000≤V_{PI}≤20,000 [Equation 1]

wherein V_{PI} is the same as defined in Equation 1 as described above.

Step (A) may be reacted by further including a compound represented by the following Formula 3:

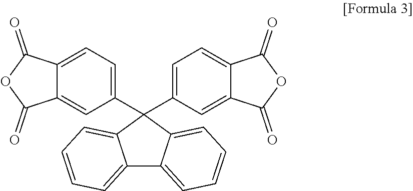 [SMILES: O=C1OC(=O)c2cc(C3(c4ccc5c(c4)C(=O)OC5=O)c4ccccc4-c4ccccc43)ccc21]

Step (B) may include: additionally adding 25 to 100% by weight of a hydrocarbon-based solvent based on the weight of the amide-based solvent in step (A) and stirring the mixture; and additionally adding a mixed solvent including the amide-based solvent and the hydrocarbon-based solvent to satisfy Equation 1.

In another general aspect, a polyimide film for a cover window is obtained by curing the composition for forming a polyimide film for a cover window as described above.

The polyimide film for a cover window may have a thickness of 30 to 500 μm, an absolute value of a retardation (Rth) in a thickness direction at a wavelength of 550 nm of 1,000 nm or less, and a yellowness index (YI) of 5 or less according to ASTM E131.

The polyimide film for a cover window may have a modulus of 3 GPa or more according to ASTM E111, a tensile strength of 100 MPa or more, and an elongation of 10% or more.

In another general aspect, a process for preparing a polyimide film for a cover window includes applying the composition for forming a polyimide film for a cover window on a substrate and then performing heat treatment.

The heat treatment may be performed by heating the composition for forming a polyimide film for a cover window at 280 to 350° C.

In another general aspect, a multilayer structure includes the polyimide film for a cover window as described above on one surface of a substrate.

In another general aspect, a cover window for a display device includes: the polyimide film for a cover window as described above; and a coating layer formed on the polyimide film.

The coating layer may be a hard coating layer, an antistatic layer, an anti-fingerprint layer, an anti-fouling layer, an anti-scratch layer, a low refractive layer, an anti-reflection layer, an impact absorbing layer, or a combination thereof

### DESCRIPTION OF THE INVENTION

Hereinafter, an embodiment of the present disclosure will be described in detail so as to be easily carried out by a person skilled in the art to which the present disclosure pertains. However, the present invention may be implemented in various different forms and is not limited to embodiments described herein. In addition, it is not intended to limit the scope of protection limited by the claims.

Further, technical terms and scientific terms used herein have the general meaning understood by those skilled in the art to which the present invention pertains, unless otherwise defined, and a description for the known function and configuration unnecessarily obscuring the gist of the present invention will be omitted in the following description.

Throughout the present specification, unless explicitly described to the contrary, “comprising” any component will be understood to imply the further inclusion of other elements rather than the exclusion of other elements.

Hereinafter, unless otherwise defined herein, when an element such as a layer, a film, a thin film, a region, or a plate is referred to as being “on” another element, it may be directly on another element or there may be on another element with the other element interposed therebetween.

Hereinafter, unless otherwise defined herein, the term “a combination thereof” may mean mixing or copolymerization of constituents.

Hereinafter, unless otherwise defined herein, “A and/or B” may refer to an aspect including both A and B, and may refer to an aspect selected from A and B.

Unless otherwise defined herein, a “polymer” includes oligomers and includes homopolymers and copolymers. The copolymer includes an alternating polymer, a block copolymer, a random copolymer, a branched copolymer, a crosslinked copolymer, or all of the aforementioned.

Hereinafter, unless otherwise defined herein, a “polyamic acid” may refer to a polymer including a structural unit having an amic acid moiety, and a “polyimide” may refer to a polymer including a structural unit having an imide moiety.

Hereinafter, unless otherwise defined herein, a “mura phenomenon” may be interpreted as a meaning that encompasses all distortions due to light that may be caused at a specific angle. For example, in a display device including a polyimide film, the distortions due to light, such as a blackout phenomenon in which a screen looks black, a hot spot phenomenon, or a rainbow phenomenon having a rainbow mura, may be mentioned.

Hereinafter, a composition for forming a polyimide film for a cover window according to an embodiment will be described.

In order to apply the polyimide film to a display device, there have been many attempts to increase optical and mechanical properties by combining or changing monomers having various structures. However, since mechanical properties and optical properties have a trade-off relationship with each other, such an attempt was not only insufficiently effective even if the optical properties were improved, but also had an extremely general result that the mechanical properties are degraded. Accordingly, there is a need for a new attempt capable of imparting both excellent mechanical properties and optical properties.

The composition for forming a polyimide film for a cover window according to an embodiment (hereinafter, also referred to as a polyimide film forming composition for a cover window) may provide a polyimide film having improved both optical properties and mechanical properties by applying a non-polar solvent that may not be used as a polymerization solvent of polyamic acid (hereinafter, also referred to as a polyimide precursor) and/or polyimide and has no affinity with the polyimide.

Specifically, the composition for forming a polyimide film for a cover window according to an embodiment may provide a polyimide film having a significantly improved yellowness index without degradation of mechanical properties and significantly reduced distortion caused by light. Accordingly, a polyimide film prepared from the composition for forming a polyimide film for a cover window according to an embodiment may be applied to a new substrate material or cover window material applicable to a foldable or flexible display device, and the polyimide film may have excellent visibility, thereby minimizing user's eye fatigue.

The composition for forming a polyimide film for a cover window according to an embodiment may include polyamic acid and/or polyimide; polar solvents; and non-polar solvents. The polar solvent may be a hydrophilic solvent, may have affinity with, for example, polyamic acid and/or polyimide, and may be, for example, an amide-based solvent. In addition, the non-polar solvent may have little affinity with polyamic acid and/or polyimide, and may be, for example, a hydrocarbon-based solvent.

The composition for forming a polyimide film for a cover window according to an embodiment includes: a polyamic acid or polyimide including a structural unit derived from a dianhydride and a structural unit derived from a diamine; and a mixed solvent of an amide-based solvent and a hydrocarbon-based solvent, the structural unit derived from the dianhydride includes a structural unit derived from a compound represented by the following Formula 1, and the structural unit derived from the diamine includes a structural unit derived from a compound represented by the following Formula 2.

In addition, the composition for forming a polyimide film for a cover window according to an embodiment may satisfy the following Equation 1. Although not wishing to be bound by a particular theory, the composition for forming a polyimide film for a cover window that satisfies these conditions, may suppress a packing density of the polyimide film during curing and make the film amorphous, thereby improving optical properties.

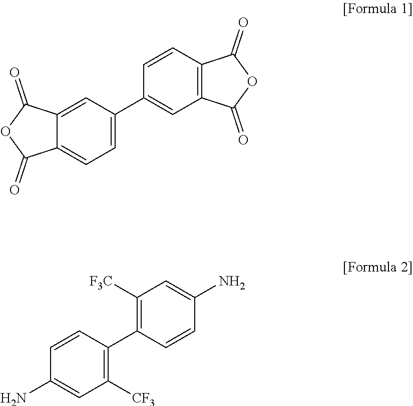 [SMILES: O=C1OC(=O)c2cc(-c3ccc4c(c3)C(=O)OC4=O)ccc21 ; Nc1ccc(-c2ccc(N)cc2C(F)(F)F)c(C(F)(F)F)c1]

7,000≤V_{PI}≤20,000 [Equation 1]

wherein

V_{PI} is a viscosity of a composition for forming a polyimide film for a cover window when a solid content is 15% by weight based on the total weight of the composition for forming a polyimide film for a cover window, and the viscosity is a viscosity (unit, cp) measured with a Brookfield rotational viscometer at 25° C. using a 52Z spindle based on a torque of 80% for 2 minutes.

The composition for forming a polyimide film for a cover window according to an embodiment has a monomer combination and mixed solvent composition as described above, and thus may provide a polyimide film for a cover window excellent in colorless and transparent performance, optical properties, and mechanical properties. Specifically, the polyimide film for a cover window according to an embodiment may be colorless and transparent and has a significantly low retardation, thereby effectively suppressing a mura phenomenon and a rainbow phenomenon and simultaneously implementing excellent mechanical properties.

The structural unit derived from the dianhydride according to an embodiment may further include a structural unit derived from a compound represented by the following Formula 3:

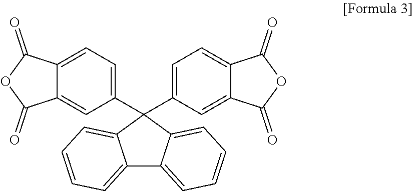

The structural unit derived from the compound represented by Formula 3 according to an embodiment may include 10 to 50 mol %, specifically 20 to 40 mol %, and more specifically 20 to 30 mol %, based on 100 mol % of the structural unit derived from the dianhydride. As the structural unit derived from the compound represented by Formula 3 is included in the above-described range, it is possible to provide a polyimide film having lower optical properties, for example, a retardation in a thickness direction, without degradation of mechanical properties.

The composition for forming a polyimide film for a cover window according to an embodiment may effectively suppress an intermolecular interaction between the polymer and the polymer and/or the interaction between the polymer and the solvent by using a mixed solvent including an amide-based solvent and a hydrocarbon-based solvent. In addition, an intermolecular packing density is significantly reduced during curing, so that both optical properties and mechanical properties may be improved.

Furthermore, the composition for forming a polyimide film for a cover window may have reduced viscosity of the composition while having a high solid content by using the mixed solvent. Accordingly, the composition for forming a polyimide film for a cover window according to an embodiment may have a high solid content and low viscosity, thereby easily forming a thin film by a solution process and providing a polyimide film having both excellent mechanical and optical properties.

Specifically, the composition for forming a polyimide film for a cover window according to an embodiment may have viscosity (V_{PI}) of 7,000 cp to 15,000 cp, or 8,000 cp to 15,000 cp, or 9,000 cp to 15,000 cp. Here, the viscosity is a viscosity when the solid content is 15% by weight based on the total weight of the composition for forming a polyimide film for a cover window. That is, the composition for forming a polyimide film for a cover window including a high solid content may be more easily applied to a thin film process, and a polyimide film having more excellent optical and mechanical properties may be provided. Here, the solid content may be the polyamic acid and/or polyimide.

In an embodiment, the amide-based solvent refers to a compound containing an amide moiety. The amide-based solvent may be a cyclic compound or a chain compound, and specifically, a chain compound. Specifically, the chain compound may have 2 to 15 carbon atoms, and more specifically, 3 to 10 carbon atoms.

The amide-based solvent may include an N,N-dialkylamide moiety, each of the dialkyl groups may exist independently, may be fused with each other to form a ring, or at least one alkyl group of the dialkyl group may be fused with another substituent in a molecule to form a ring, for example, at least one alkyl group of the dialkyl group may be fused with an alkyl group connected to a carbonyl carbon of an amide moiety to form a ring. Here, the ring may be a 4- to 7-membered ring, for example, a 5- to 7-membered ring, for example, a 5-membered or 6-membered ring. The alkyl group may be, for example, a C₁₋₁₀ alkyl group, for example, a C₁₋₈ alkyl group, for example, methyl or ethyl.

More specifically, the amide-based solvent is not limited as long as it is generally used for polymerization of polyamic acid, but may include, for example, dimethylpropionamide, diethylpropionamide, dimethylacetylamide, diethylacetamide, dimethylformamide, methylpyrrolidone, ethylpyrrolidone, octylpyrrolidone, or a combination thereof, and specifically may include dimethylpropionamide.

In one embodiment, the hydrocarbon-based solvent may be a non-polar molecule as described above. The hydrocarbon solvent may be a compound consisting of carbon and hydrogen. For example, the hydrocarbon-based solvent may be aromatic or aliphatic, for example, may be a cyclic compound or a chain compound, but specifically, may be a cyclic compound. Here, when the hydrocarbon solvent is a cyclic compound, it may include a single ring or a polycyclic ring, and the polycyclic ring may be a condensed ring or a non-condensed ring, but specifically may be a single ring.

The hydrocarbon-based solvent may have 3 to 15 carbon atoms, for example, 6 to 15 carbon atoms, for example, 6 to 12 carbon atoms. The hydrocarbon-based solvent may be a substituted or unsubstituted C₃₋₁₅ cycloalkane, a substituted or unsubstituted C₆₋₁₅ aromatic compound, or a combination thereof. Here, the cycloalkane may include cyclobutane, cyclopentane, cyclohexane, cycloheptane, cyclooctane, or a combination thereof, and the aromatic compound may include benzene, naphthalene, or a combination thereof. The hydrocarbon-based solvent may be a cycloalkane unsubstituted or substituted with at least one C₁₋₅ alkyl group, an aromatic compound substituted or unsubstituted with at least one C₁₋₅ alkyl group, or a combination thereof, wherein the cycloalkane and aromatic compounds are as described above, respectively. The C₁₋₅ alkyl group may be, for example, a C₁₋₃ alkyl group, for example, a C₁₋₂ alkyl group, and more specifically, may be a methyl group, but the present invention is not limited thereto. In addition, the hydrocarbon-based solvent may further include oxygen if necessary. For example, when the hydrocarbon-based solvent contains oxygen, it may include a ketone group or a hydroxyl group, for example, cyclopentanone, cresol, or a combination thereof. Specifically, the hydrocarbon-based solvent may include, but is not limited to, benzene, toluene, cyclohexane, cyclopentanone, cresol, or a combination thereof.

More specifically, the composition for forming a polyimide film for a cover window according to an embodiment may include a mixed solvent including an amide-based solvent including dimethylpropionamide and a hydrocarbon-based solvent selected from toluene, benzene, and cyclohexane.

In addition, the hydrocarbon-based solvent and the mixed solvent according to an embodiment may be added after polymerization of polyamic acid or polyimide.

Accordingly, the composition for forming a polyimide film for a cover window according to an embodiment may exhibit intermolecular behavior and interaction different from that when a mixed solution is simply added in the polymerization step of the polyamic acid. For example, when the hydrocarbon-based solvent is mixed in the step of polymerizing the polyamic acid, a high molecular weight polyamic acid may not be obtained by acting as a factor interrupting polymerization. Meanwhile, in the composition for forming a polyimide film for a cover window according to an embodiment, after obtaining a polyamic acid and/or polyimide having a sufficient high molecular weight, a hydrocarbon-based solvent is mixed, the hydrocarbon-based solvent may serve as a catalyst for weakening intermolecular interaction and/or strong interaction between the polymer and the solvent, and desired optical properties may be obtained during subsequent curing. Here, the interaction between the polyamic acid, which is a polyimide precursor, and the solvent may be adjusted to a more appropriate range by sequentially using the amide-based solvent and the hydrocarbon-based solvent. Here, the adjustment may mean inhibition.

The composition for forming a polyimide film for a cover window according to an embodiment may include the amide-based solvent and the hydrocarbon-based solvent in a weight ratio of 8:2 to 5:5, specifically, in a weight ratio of 7.5:2.5 to 5:5, or 7.5:2.5 to 5.5:4.5. More excellent optical properties may be implemented and excellent reactivity of diamine and dianhydride may be maintained by including the amide-based solvent and the hydrocarbon-based solvent in the above weight ratio. In addition, upon curing the composition for forming a polyimide film for a cover window, the composition may more appropriately suppress the intermolecular packing density and make the film amorphous. Accordingly, it is possible to provide the polyimide film for a cover window with further improved optical properties even at a thickness of 30 μm or more.

The composition for forming a polyimide film for a cover window according to an embodiment may provide a film having more excellent mechanical properties and optical properties, for example, a yellowness index by including the diamine represented by Formula 2. In addition, the diamine may be used in combination with one or two or more selected from p-phenylenediamine (PDA), m-phenylenediamine (m-PDA), 4,4′-oxydianiline (4,4′-ODA), 3,4′-oxydianiline (3,4′-ODA), 2,2-bis (4-[4-aminophenoxy]-phenyl)propane (BAPP), 1,4-bis(4-aminophenoxy)benzene (TPE-Q), 1,3-bis (4-aminophenoxy) benzene (TPE-R), 4,4′-bis(4-aminophenoxy)biphenyl (BAPB), bis (4-[4-aminophenoxy] phenyl)sulfone (BAPS), (bis (4-[3-aminophenoxy] phenyl) sulfone (m-BAPS), 3,3′-dihydroxy-4,4′-diaminobiphenyl (HAB), 3,3-dimethylbenzidine (TB), 2,2-dimethylbenzidine (m-TB), 1,4-bis(4-amino-2-trifluoromethylphenoxy)benzene (6FAPB), 2,2′-bis(trifluoromethyl)-4,4′-diaminodiphenyl ether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, and 5-amino-2-(4-aminophenyl)benzoxazole, etc., if necessary, but the present invention is not limited thereto.

The composition for forming a polyimide film for a cover window according to an embodiment may provide a film having improved mechanical strength and optical properties by including one or two or more dianhydrides selected from Formulas 1 and 3.

In addition, the dianhydride may further include pyromellitic dianhydride (PMDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), p-phenylenebistrimelic monoester anhydride (TMHQ), 2,2′-bis(4-hydroxyphenyl)propanedibenzoate-3,3′,4,4′-tetracarboxylic dianhydride (ESDA), naphthalene tetracarboxylic dianhydride (NTDA), or a combination thereof, if necessary.

The composition for forming a polyimide film for a cover window according to an embodiment may include a polyamic acid and/or a polyimide including a structural unit derived from the diamine and dianhydride exemplified above.

The weight average molecular weight (Mw) of the polyamic acid and/or polyimide is not particularly limited, but may be 10,000 g/mol or more, for example, 20,000 g/mol or more, for example, 25,000 to 100,000 g/mol. In addition, a glass transition temperature is not limited, but may be 100 to 400° C., and more specifically 100 to 380° C. In the above range, it is preferable to provide a film having more excellent optical properties, more excellent mechanical strength, and less curling, but the present invention is not necessarily limited thereto.

The solid content of the composition for forming a polyimide film for a cover window according to an embodiment may satisfy the range of 10 to 40% by weight, or 10 to 35% by weight or less, or 10 to 20% by weight based on the total weight of the composition for forming a polyimide film for a cover window. Here, the solid content may be the polyamic acid and/or polyimide.

In general, in the case of polyimide, the higher the concentration of the solid content, the higher the viscosity tends to be. For example, when the above-described polyamic acid and/or polyimide is dissolved in a conventional amide-based solvent alone, the viscosity of the solution may be 20,000 cp or more, or 30,000 cp or more. Here, the viscosity of the solution refers to a viscosity when the solid content is 15% by weight based on the total weight of the solution. When a thin film is manufactured by a solution process, for example, a coating process, if the flow of the polymer is not good due to high viscosity, it is difficult to remove bubbles and mura may occur during coating.

On the other hand, the composition for forming a polyimide film for a cover window according to an embodiment may significantly reduce the viscosity of the composition even if it contains a high solid content of 15% by weight or more by using a mixed solvent of an amide-based solvent and a hydrocarbon-based solvent. Accordingly, it may be applied to a thin film coating process with high solids content and low viscosity, process efficiency may be improved, and desired physical properties may be more effectively implemented.

Hereinafter, a process for preparing a composition for forming a polyimide film for a cover window according to an embodiment will be described.

A process for preparing a composition for forming a polyimide film for a cover window according to an embodiment may include the steps of: step (A) preparing a polyamic acid solution by reacting a compound represented by the Formula 1 and a compound represented by the Formula 2 in an amide-based solvent; and step (B) adjusting a viscosity by additionally adding a hydrocarbon-based solvent to satisfy the Equation 1.

Step (A) according to an embodiment may be reacted by further including a compound represented by the Formula 3.

Specifically, step (A) may include: polymerizing polyamic acid by mixing diamine and dianhydride in an equivalent ratio of 1:1 to 1:1.1, wherein the diamine is dissolved in an amide-based solvent; performing dissolution by adding dianhydride to the solution; and stirring the reaction solution for 5 to 7 hours to react them.

Step (B) according to an embodiment may be additionally adding the above-described hydrocarbon solvent and stirring, and then additionally adding a mixed solvent including an amide-based solvent and a hydrocarbon-based solvent, through which the viscosity range of the composition for forming a polyimide film for a cover window may satisfy the Equation 1.

Specifically, step (B) according to an embodiment may include: additionally adding 20 to 100% by weight or 20 to 50% by weight of a hydrocarbon-based solvent based on the weight of the amide-based solvent in step (A) at room temperature (25° C.) and performing stirring for 15 to 20 hours; and after stirring is completed, adding a mixed solvent including the amide-based solvent and the hydrocarbon-based solvent to satisfy the Equation 1. Although not wishing to be bound by a particular theory, the composition for forming a polyimide film for a cover window that satisfies these conditions, may suppress the packing density of the polyimide film during curing and make the film amorphous. Accordingly, it is possible to provide a polyimide film having a further improved yellowness index and a retardation in a thickness direction without degradation of mechanical properties.

In addition, the composition for forming a polyimide film for a cover window according to an embodiment may exhibit intermolecular behavior and interaction different from that when a mixed solution is simply added in the polymerization step of the polyamic acid. For example, when the hydrocarbon-based solvent is included in the step of polymerizing the polyamic acid, a high molecular weight polyamic acid may not be obtained by acting as a factor interrupting polymerization.

On the other hand, after obtaining a polyamic acid and/or polyimide having a sufficient high molecular weight, a hydrocarbon-based solvent may be mixed in the composition for forming a polyimide film for a cover window according to an embodiment, thereby obtaining a high molecular weight polyamic acid. In addition, the hydrocarbon-based solvent may act as a catalyst to weaken the intermolecular interaction between the polymers and/or the strong interaction between the polymer and the solvent, and thus, desired optical properties may be obtained during subsequent curing. In general, optical properties such as a retardation (Rth) in a thickness direction and a yellowness index, and mechanical properties such as modulus, have a trade-off relationship with each other, and it is difficult to simultaneously improve these properties. However, according to an embodiment, these physical properties may be simultaneously improved even at a thickness of 30 μm or more.

In addition, another embodiment may be a polyimide film for a cover window manufactured from the composition for forming a polyimide film for a cover window.

The polyimide film for a cover window according to an embodiment may have a thickness of 30 to 500 um, for example, 40 to 300 um, for example, 50 to 200 um. Further, an absolute value of the retardation (Rth) in the thickness direction at a wavelength of 550 nm may be 200 to 1,000 nm, for example, 300 to 1,000 nm, for example, 500 to 1,000 nm. Also, the yellowness index (YI) according to ASTM E131 may simultaneously satisfy physical properties of 5 or less, or 4.5 or less, or 4 or less. That is, the polyimide film for a cover window according to an embodiment may significantly reduce the distortion due to light without degradation of the yellowness even at a thickness of 30 μm or more.

In addition, the polyimide film for a cover window according to an embodiment may have a modulus of 3 GPa or more according to ASTM E111, a tensile strength of 100 MPa or more, and an elongation of 10% or more. More specifically, the above-described retardation (Rth) in the thickness direction at a wavelength of 550 nm and yellowness may simultaneously satisfy such mechanical properties.

Specifically, the polyimide film for a cover window according to an embodiment may have a modulus of 3 GPa or more, or 3.5 GPa or more, or 4 GPa to 6 GPa according to ASTM E111, a tensile strength of 100 MPa or more, or 110 MPa or more, or 110 MPa to 200 MPa, and an elongation of 10% or more, or 11% or more, or 10% to 30%. That is, the polyimide film according to an embodiment may implement mechanical properties and durability sufficient to be applied to a cover window.

As the polyimide film for a cover window according to an embodiment satisfies the retardation in the thickness direction, the yellowness index, and the modulus in the above-described ranges, the image distortion due to light may be prevented, thereby providing further improved visibility. In addition, it is possible to exhibit more uniform mechanical properties (modulus, etc.) and optical properties (retardation in the thickness direction, etc.) as a whole in a central portion and an edge portion of the film as a whole, and further reduce film loss. In addition, the polyimide film is flexible and has excellent bending properties, and thus may be more easily restored to its original shape without deformation and/or damage even when a predetermined deformation occurs repeatedly. In addition, the cover window including the polyimide film according to an embodiment may have better visibility and may prevent the occurrence of fold marks and microcracks, and thus may impart superior durability and long-term lifespan to a foldable display device or a flexible display device.

Hereinafter, a method of manufacturing a polyimide film for a cover window according to an embodiment will be described.

In another general aspect, the method of manufacturing a polyimide film for a cover window according to an embodiment may include applying the composition for forming a polyimide film for a cover window according to an embodiment to a substrate and then performing heat treatment.

Specifically, the application may be used without limitation as long as it is commonly used in the field. Non-limiting examples thereof may include knife coating, dip coating, roll coating, slot die coating, lip die coating, slide coating, and coating, etc., and for this, the same type or different types may be sequentially applied one or more times.

In addition, the substrate may be used without limitation as long as it is conventionally used in the art, and non-limiting examples thereof may include, but are not limited to, glass; stainless; or plastic films such as polyethylene terephthalate, polyethylene naphthalate, polypropylene, polyethylene, cellulose triacetate, cellulose diacetate, poly (meth) acrylic acid alkyl ester, poly (meth) acrylic acid ester copolymer, polyvinyl chloride, polyvinyl alcohol, polycarbonate, polystyrene, cellophane, polyvinylidene chloride copolymer, polyamide, polyimide, vinyl chloride vinyl acetate copolymer, polytetrafluoroethylene, and polytrifluoroethylene, etc.

In addition, the polyimide film for a cover window according to an embodiment may have an adhesive strength of 5 gf/in or more, or 10 gf/in or more, or 15 gf/in or more to a substrate such as glass. The polyimide film according to an embodiment has reduced intermolecular density, and thus screen distortion may not be caused when the polyimide film is applied to a cover window of a flexible display.

In the method of manufacturing a polyimide film for a cover window according to an embodiment, the heat treatment in the heat treatment step may be performed at a temperature of greater than or equal to 280° C. and less than or equal to 350° C. for 10 minutes to 60 minutes. When curing is performed at a relatively low temperature, the film may receive less thermal history, and thus may tend to have lower yellowness index. However, when the film is cured at or below the glass transition temperature (T g), there may be problems in that the mechanical properties of the film are degraded or the retardation in the thickness direction is increased due to an orientation problem of the molecular structure. On the other hand, the polyimide film according to an embodiment may improve mechanical properties even when heat treatment is performed at a temperature of 280° C. to 350° C. or 300° C. to 350° C., may arrange polymer chains more isotropically, and may further reduce the retardation in the thickness direction. That is, the polyimide film according to an embodiment may simultaneously implement excellent yellowness index, retardation, and mechanical properties. In addition, the heat treatment may be performed for, for example, 10 minutes to 50 minutes, 10 minutes to 40 minutes, 10 minutes to 30 minutes, or 10 minutes to 20 minutes, but the present invention is not necessarily limited thereto. In addition, thermal curing may be performed, for example, in a separate vacuum oven, an oven filled with an inert gas, etc.

Also, before the heat treatment step, a drying step may be additionally performed, if necessary. The drying step may be performed at a temperature of 50° C. to 150° C., 50° C. to 130° C., 60° C. to 100° C., or about 80° C., but the present invention is not necessarily limited thereto.

The method for manufacturing a polyimide film for a cover window may further include, if necessary, applying the composition for forming a polyimide film for a cover window on a substrate and then leaving the composition at room temperature. The optical properties of the film surface may be more stably maintained through the leaving step. Although not wishing to be bound by a particular theory, when in the conventional composition for forming a polyimide film is subjected to such a leaving step before curing, the solvent may absorb moisture in the air and moisture may be diffused therein. Accordingly, moisture may collide with the polyamic acid and/or polyimide to cause cloudiness from the surface of the film, and agglomeration may occur, resulting in coating non-uniformity. On the other hand, it is possible to implement the advantage that the composition for forming a polyimide film for a cover window according to an embodiment may not have cloudiness and agglomeration even when left in the air for a long time, and may ensure a film having improved optical properties. The leaving step may be performed under conditions of room temperature and/or high humidity. Here, the room temperature may be 40° C. or less, for example, 30° C. or less, for example, 25° C. or less, more specifically 15° C. to 25° C., and particularly preferably 20° C. to 25° C. In addition, the high humidity may be, for example, a relative humidity of 50% or more, for example, 60% or more, for example, 70% or more, for example, 80% or more. The leaving step may be performed for 1 minute to 3 hours, for example, 10 minutes to 2 hours, for example, 20 minutes to 1 hour.

In the method for manufacturing a polyimide film for a cover window according to an embodiment, a polyimide film for a cover window may be manufactured by mixing one or more additives selected from flame retardants, adhesion enhancers, inorganic particles, antioxidants, UV inhibitors, and plasticizers in the polyamic acid solution.

Hereinafter, a use of a polyimide film for a cover window according to an embodiment will be described.

An aspect may be a multilayer structure including the polyimide film according to an embodiment. For example, the multi-layer structure may be a cover window for a display device, including a polyimide film for a cover window; and a coating layer formed on the polyimide film. The coating layer may include, as a non-limiting example, a hard coating layer, an antistatic layer, an anti-fingerprint layer, an anti-fouling layer, an anti-scratch layer, a low refractive layer, an anti-reflection layer, a shock-absorbing layer, etc., and may include at least one or two or more functional coating layers. In this case, the coating layer may have a thickness of 1 μm to 500 μm, 2 μm to 450 μm, or 2 μm to 200 μm, but the present invention is not limited thereto.

Another aspect may be a display device including the polyimide film for a cover window according to an embodiment.

As described above, the polyimide film according to an embodiment may have excellent optical and mechanical properties, and specifically, may exhibit sufficiently low retardation even at various angles, and thus may be applied to various industrial fields that require securing a wide viewing angle.

For example, the display device is not particularly limited as long as it is a field requiring excellent optical properties, and a display panel suitable therefor may be selected and provided. Specifically, the display device may be applied to a flexible display device, and non-limiting examples thereof may include, but are not limited to, various image display devices, such as a liquid crystal display device, an electroluminescence display device, a plasma display device, a field emission display device, etc.

In addition, the display device including a polyimide film according to an embodiment may not only have excellent display quality, but also significantly reduce distortions due to light. In particular, the rainbow phenomenon in which rainbow mura is generated may be significantly improved, and excellent visibility may minimize the user's eye fatigue. In addition, as a screen size of the display device increases, the case of viewing the screen from a side increases. When the polyimide film for a cover window according to an embodiment is applied to the display device, since visibility is excellent even from a side, the display device may be usefully applied to a large-sized display device.

Hereinafter, an exemplary embodiment is described for a detailed description of an embodiment, but the present invention is not limited thereto.

In the following experiment, the physical properties were measured as follows.

<Viscosity (V_{PI})>

A viscosity value was measured when 0.5 ul of the composition was placed in a container, a spindle was lowered, rpm was adjusted to wait for 2 minutes when the torque reached 80%, and then there was no change in the torque. In this case, the viscosity was measured under a temperature condition of 25° C. using a 52Z spindle. The viscosity is represented by cp.

<Yellow Index (YI)>

The yellowness Index was measured using a Spectrophotometer (Nippon Denshoku, COH-5500) according to ASTM E313 standard.

<Retardation (Rth)>

The retardation was measured using an Axoscan (OPMF, Axometrics Inc.). The retardation (Rth) in the thickness direction was measured for a wavelength of 400 nm to 800 nm, and an absolute value was expressed based on a wavelength of 550 nm. The retardation is represented by nm.

<Modulus>

The modulus was measured using a UTM 3365 (Instron Corp.) under the conditions of pulling a sample having a thickness of 50 μm, a length of 50 mm, and a width of 10 mm at 25° C. at 50 mm/min according to ASTM E111. The modulus is represented by GPa.

### Example 1

Preparation of Composition for Forming Polyimide Film for Cover Window

180 g of N,N-dimethylpropionamide (DMPA) was placed into a stirrer through which a nitrogen stream flowed, and 22.68 g of 2,2′-bistrifluoromethylbenzidine (TFMB) was dissolved while the temperature of the reactor was maintained at 25° C. 16.7 g of 3,3′,4,4′-biphenyltetracarboxylic dianhydride (BPDA) and 6.5 g of 9,9-bis (3,4-dicarboxyphenyl)fluorene dianhydride (BPAF) at room temperature was added thereto and stirred for 6 hours to prepare a polyamic acid solution. Then, 77 g of toluene was added thereto at 25° C., and the mixture was stirred for 18 hours. Thereafter, a composition for forming a polyimide film for a cover window having a viscosity of 12,000 cp was prepared by adding a mixed solvent of DMPA:toluene=70% by weight:30% by weight so that a solid content was 15% by weight based on the total weight of the composition.

Manufacture of Polyimide Film for Cover Window

A polyimide film for a cover window of Example 1 having a thickness of 50 μm was obtained by applying the composition for forming a polyimide film for a cover window obtained above to one surface of a glass substrate (1.0T) with a meyer bar, drying the composition at 80° C. for 30 minutes under a nitrogen stream, heating and curing the dried composition at 300° C. for 15 minutes, and then peeling the resulting film from a glass substrate. The physical properties are shown in Table 2 below.

### Examples 2 to 4

Compositions for forming polyimide films for cover windows of Examples 2 to 4 were prepared in the same manner as in Example 1, except that the monomers of the molar ratios shown in Table 1 below were used. In addition, polyimide films for cover windows of Examples 2 to 4 each having a thickness of 50 μm were prepared in the same manner as in Example 1. The physical properties are shown in Table 2 below.

### Examples 5 and 6

The compositions for forming polyimide films for cover windows of Examples 5 and 6 were prepared in the same manner as in Example 1, except that a toluene content (T content) with respect to the total weight of DMPA and toluene in the compositions for forming polyimide films for cover windows was adjusted as shown in Table 1 below. In addition, the polyimide films for cover windows of Examples 5 to 6 each having a thickness of 50 μm were prepared in the same manner as in Example 1. The physical properties are shown in Table 2 below.

### Comparative Example 1

Preparation of Composition for Forming Polyimide Film for Cover Window

211 g of N,N-dimethylpropionamide (DMPA) was placed into a stirrer through which a nitrogen stream flowed, and 22.68 g of 2,2-bistrifluoromethylbenzidine (TFMB) was dissolved while the temperature of the reactor was maintained at 25° C. 16.7 g of 3,3′,4,4′-biphenyltetracarboxylic dianhydride (BPDA) and 6.5 g of 9,9-bis (3,4-dicarboxyphenyl)fluorene dianhydride (BPAF) at room temperature was added thereto and stirred for 24 hours to prepare a polyamic acid solution. Thereafter, DMPA was added so that the solid content was 15% by weight based on the total weight of the composition at 25° C. to prepare a composition for forming a polyimide film for a cover window having a viscosity of 23,000 cp.

Manufacture of Polyimide Film for Cover Window

A polyimide film for a cover window of Comparative Example 1 having a thickness of 50 μm was obtained by applying the composition for forming a polyimide film for a cover window obtained above to one surface of a glass substrate (1.0T) with a meyer bar, drying the composition at 80° C. for 30 minutes under a nitrogen stream, heating and curing the dried composition at 300° C. for 15 minutes, and then peeling the resulting film from a glass substrate. The physical properties are shown in Table 2 below.

### Comparative Examples 2 and 3

The compositions for forming polyimide films for cover windows of Comparative Examples 2 and 3 were prepared in the same manner as in Example 1, except that a toluene content (T content) with respect to the total weight of DMPA and toluene in the compositions for forming polyimide films for cover windows was adjusted as shown in Table 1 below. In addition, the polyimide films for cover windows of Examples 2 to 3 each having a thickness of 50 μm were prepared in the same manner as in Example 1. The physical properties are shown in Table 2 below.

TABLE 1

| | Diamine | Dianhydride | | T content |
|---|---|---|---|---|
| | TFMB | BPDA | BPAF | (wt %) |
| Example 1 | 0.99 | 80 | 20 | 30 |
| Example 2 | 0.99 | 75 | 25 | 30 |
| Example 3 | 0.99 | 70 | 30 | 30 |
| Example 4 | 0.99 | 50 | 50 | 30 |
| Example 5 | 0.99 | 80 | 20 | 25 |
| Example 6 | 0.99 | 80 | 20 | 45 |
| Comp. Example 1 | 0.99 | 80 | 20 | 0 |
| Comp. Example 2 | 0.99 | 80 | 20 | 10 |
| Comp. Example 3 | 0.99 | 80 | 20 | 60 |

TABLE 2

| | | | | | | | Comparative | | |
|---|---|---|---|---|---|---|---|---|---|
| | Examples | | | | | | Examples | | |
| | 1 | 2 | 3 | 4 | 5 | 6 | 1 | 2 | 3 |
| Viscosity | 12,000 | 13,000 | 15,000 | 14,000 | 13,000 | 9,500 | 23,000 | 21,000 | Not |
| (cP) | | | | | | | | | available |
| Thickness | 50 | 50 | 50 | 50 | 50 | 50 | 50 | 50 | |
| (μm) | | | | | | | | | |
| YI | 3.1 | 3.1 | 3.1 | 3.4 | 3.2 | 3.0 | 3.7 | 3.6 | |
| Rth | 980 | 820 | 730 | 510 | 550 | 480 | 1110 | 1050 | |
| (@550 nm) | | | | | | | | | |
| Modulus | 4.1 | 4.1 | 4.1 | 4.1 | 4.1 | 4.0 | 4.2 | 4.2 | |
| (GPa) | | | | | | | | | |

It can be confirmed from Table 2 that the compositions for forming polyimide films for cover windows according to Examples 1 to 6, including a mixed solvent of an amide-based solvent and a hydrocarbon-based solvent, may have a viscosity of 7,000 to 20,000 cp, and films having thicknesses sufficient to be used as cover films of flexible displays may be formed. In addition, all of the polyimide films manufactured using the compositions had excellent optical and mechanical properties.

On the other hand, the polyimide film of Comparative Example 1 prepared from a composition not including a mixed solvent including an amide-based solvent and a hydrocarbon-based solvent, exhibited significant degradation in the yellowness index and the retardation in the thickness direction compared to the polyimide films of Examples 1 and 6 having the same monomer molar ratio and heat treatment temperature.

In addition, the composition of Comparative Example 3 had a high initial polymerization solid content, and the solution viscosity became uncontrollably high, which made it impossible to measure the viscosity and polymerize, and the composition of Comparative Example 2 had a high viscosity compared to the solid content and was disadvantageous in the process because air bubbles were not removed, and the coating surface prepared therefrom was produced unevenly. Therefore, it can be confirmed that after curing, the surface of the coating layer was somewhat rough, was evaluated as defective, and was unsuitable for manufacturing a polyimide film. Furthermore, it was confirmed that the composition for forming a polyimide film for a cover window of Comparative Example 2 had a rough surface after coating and thus a retardation value was significantly increased.

The composition for forming a polyimide film for a cover window according to an embodiment may suppress the interaction between the polyamic acid and the mixed solvent to significantly reduce a packing density between molecules during curing. Accordingly, a polyimide film capable of implementing colorless and transparent optical properties even in a thickness range having a mechanical strength similar to that of tempered glass may be provided.

In addition, the composition for forming a polyimide film for a cover window according to an embodiment may significantly reduce the viscosity of the composition even if it contains a high solid content by using a mixed solvent of an amide-based solvent and a hydrocarbon-based solvent. Accordingly, the composition for forming a polyimide film for a cover window may be applied to a thin film coating process with high solids content and low viscosity, and may effectively implement desired physical properties.

Specifically, the polyimide film for a cover window according to an embodiment may secure a significantly suppressed yellowness index and have a remarkably low retardation in the thickness direction in the visible ray region. Accordingly, when the polyimide film for a cover window is used as a cover window of the display panel, a mura phenomenon and a rainbow phenomenon, which are problems of visibility, are effectively suppressed, thereby increasing the reliability of the display panel including the polyimide film for a cover window.

In addition, the polyimide film for a cover window according to an embodiment has excellent high-strength properties and bending properties, and may effectively prevent breakage or cracks due to bending, and thus may be applied to various industrial fields such as flexible displays.

Hereinabove, although an embodiment has been described by way of limited examples, the limited embodiments, they have been provided only for assisting in a more general understanding of the present invention. Therefore, the present invention is not limited to the examples. Various modifications and changes may be made by those skilled in the art to which the present invention pertains from this description.

Therefore, the spirit of the present invention should not be limited to the above-mentioned examples, but the claims and all of the modifications equal or equivalent to the claims are intended to fall within the scope and spirit of the present invention.

1. A composition for forming a polyimide film for a cover window, comprising: a polyamic acid or polyimide comprising a structural unit derived from a dianhydride and a structural unit derived from a diamine; and a mixed solvent of an amide-based solvent and a hydrocarbon-based solvent,
wherein the composition satisfies the following Equation 1, and
the structural unit derived from the dianhydride comprises a structural unit derived from a compound represented by the following Formula 1, and the structural unit derived from the diamine comprises a structural unit derived from a compound represented by the following Formula 2: 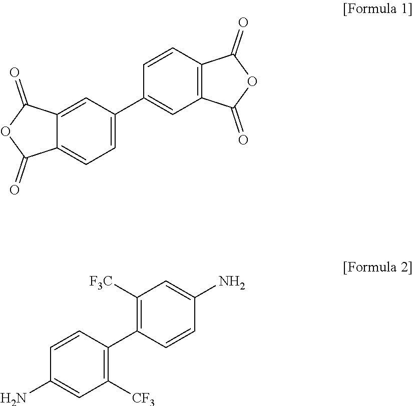
7,000≤V_{PI}≤20,000 [Equation 1]
wherein
V_{PI} is a viscosity of a composition for forming a polyimide film for a cover window when a solid content is 15% by weight based on the total weight of the composition for forming a polyimide film for a cover window, and the viscosity is a viscosity (unit, cp) measured with a Brookfield rotational viscometer at 25° C. using a 52Z spindle based on a torque of 80% for 2 minutes.

2. The composition of claim 1, wherein the structural unit derived from the dianhydride further comprises a structural unit derived from a compound represented by the following Formula 3:

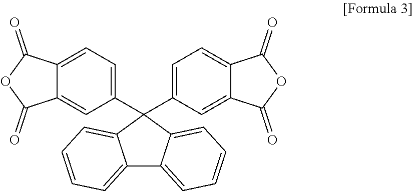

3. The composition of claim 2, wherein the structural unit derived from the compound represented by Formula 3 is comprised in an amount of 10 to 50 mol % based on 100 mol % of the structural unit derived from the dianhydride.

4. The composition of claim 1, wherein the amide-based solvent comprises dimethylpropionamide.

5. The composition of claim 1, wherein the hydrocarbon-based solvent is a cyclic hydrocarbon-based solvent.

6. The composition of claim 5, wherein the cyclic hydrocarbon-based solvent is toluene, benzene, cyclohexane, or a combination thereof.

7. The composition of claim 1, wherein the composition for forming a polyimide film for a cover window comprises the amide-based solvent and the hydrocarbon-based solvent in a weight ratio of 8:2 to 5:5.

8. The composition of claim 1, wherein the solid content of the composition for forming a polyimide film for a cover window is comprised in an amount of 10 to 40% by weight based on the total weight of the composition for forming a polyimide film.

9. A process for preparing a composition for forming a polyimide film for a cover window, the process comprising the steps of: step (A) preparing a polyamic acid solution by reacting a compound represented by the following Formula 1 and a compound represented by the following Formula 2 in an amide-based solvent; and
step (B) adjusting a viscosity by additionally adding a hydrocarbon-based solvent to satisfy the following Equation 1: 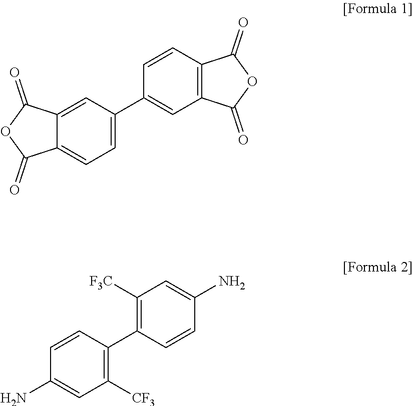 [SMILES: O=C1OC(=O)c2cc(-c3ccc4c(c3)C(=O)OC4=O)ccc21 ; Nc1ccc(-c2ccc(N)cc2C(F)(F)F)c(C(F)(F)F)c1]
7,000≤V_{PI}≤20,000 [Equation 1]
wherein
V_{PI} is the same as defined in Equation 1 of claim 1.

10. The process of claim 9, wherein step (A) is reacted by further comprising a compound represented by the following Formula 3:

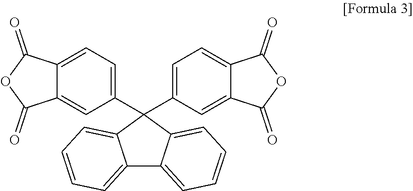 [SMILES: O=C1OC(=O)c2cc(C3(c4ccc5c(c4)C(=O)OC5=O)c4ccccc4-c4ccccc43)ccc21]

11. The process of claim 9, wherein step (B) comprises:
additionally adding 25 to 100% by weight of a hydrocarbon-based solvent based on the weight of the amide-based solvent in step (A) and stirring the mixture; and
additionally adding a mixed solvent comprising the amide-based solvent and the hydrocarbon-based solvent to satisfy Equation 1.

12. A polyimide film for a cover window obtained by curing the composition for forming a polyimide film for a cover window of claim 1.

13. The polyimide film for a cover window of claim 12, wherein the polyimide film for a cover window has a thickness of 30 to 500 μm, an absolute value of a retardation (Rth) in a thickness direction at a wavelength of 550 nm of 1,000 nm or less, and a yellowness index (YI) of 5 or less according to ASTM E131.

14. The polyimide film for a cover window of claim 13, wherein the polyimide film for a cover window has a modulus of 3 GPa or more according to ASTM E111, a tensile strength of 100 MPa or more, and an elongation of 10% or more.

15. A process for preparing a polyimide film for a cover window, the process comprising: applying the composition for forming a polyimide film for a cover window of claim 1 on a substrate and then performing heat treatment.

16. The process of claim 15, wherein the heat treatment is performed by heating the composition for forming a polyimide film for a cover window at 280 to 350° C.

17. A multilayer structure comprising: the polyimide film for a cover window of claim 12 on one surface of a substrate.

18. A cover window for a display device comprising:
the polyimide film for a cover window of claim 12; and
a coating layer formed on the polyimide film.

19. The cover window for a display device of claim 18, wherein the coating layer is a hard coating layer, an antistatic layer, an anti-fingerprint layer, an anti-fouling layer, an anti-scratch layer, a low refractive layer, an anti-reflection layer, an impact absorbing layer, or a combination thereof.
